(19) United States
(12) Patent Application Publication
(10) Pub. No.: US 2007/0209505 A1
(43) Pub. Date: Sep. 13, 2007

(54) High Flux Mixed Matrix Membranes for Separations

(76) Inventors: Chunqing Liu, Schaumburg, IL (US); Santi Kulprathipanja, Inverness, IL (US); Stephen T. Wilson, Libertyville, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/679,142

(22) Filed: Feb. 26, 2007

Related U.S. Application Data
(60) Provisional application No. 60/781,298, filed on Mar. 10, 2006.

(51) Int. Cl. B01D 53/22

(52) U.S. Cl. 95/45

(57) ABSTRACT

The present invention discloses a new class of high flux mixed matrix membranes that are made by incorporating porous inorganic fillers (e.g. microporous and mesoporous molecular sieves, carbon molecular sieves, porous metal-organic frameworks) into a high flux high surface area microporous organic polymer matrix. These microporous organic polymers are referred to as “polymers of intrinsic microporosity” or PIMs. The high flux membranes are promising for a wide range of separations including liquid separations such as pervaporation of phenol/water and also gas separations in the petrochemical, refinery, and natural gas industries such as methane/carbon dioxide, olefin/paraffin and iso/normal paraffins separations.

### CROSS-REFERENCE TO RELATED APPLICATION

This application claims priority from Provisional Application Ser. No. 60/781,298 filed Mar. 10, 2006, the contents of which are hereby incorporated by reference.

### BACKGROUND OF THE INVENTION

This invention pertains to high flux mixed matrix membranes and methods of making the same. This invention also pertains to the use of these high flux mixed matrix membranes for a wide range of separations including liquid separations such as pervaporation of phenol/water and also gas separations in petrochemical, refinery, and natural gas industries such as olefin/paraffin and iso/normal paraffins separations.

Membrane-based separations are of special interest to petroleum producers and refiners, chemical companies, and industrial gas suppliers. In the last 30-35 years polymer membrane-based separation and purification processes have evolved rapidly. Polymers provide a range of properties including low cost, high permeability, good mechanical stability, and ease of processability that are important for gas separation.

Recently, McKeown et al. reported the synthesis of new polymers that are described as being polymers of intrinsic microporosity (PIMs), bridging the void between microporous and polymeric materials. These polymers can exhibit behavior analogous to that of conventional microporous materials, but, in addition, due to their polymer properties can be readily processed into convenient forms for use as membranes. Pure polymer membranes have previously been prepared directly from some of these polymers possessing intrinsic microporosity and O₂ over N₂ gas separation performance was evaluated. See WO 2005/012397A2. However, the polymeric membranes prepared from PIM materials have never been tested or suggested as useful in iso/normal paraffin separations, as well as many other filtrations and separations.

Inorganic membranes were developed during World War II for uranium isotopes separation. Both polymer and inorganic membranes, however, have inherent limitations in terms of one or more of the following desirable membrane properties: selectivity, permeability (or flux), and stability. To enhance membrane flux and selectivity, a new type of membrane, mixed matrix membranes, has recently been developed by imbedding inorganic fillers in a continuous polymer matrix. Mixed matrix membranes have advantages that combine the best features of both organic polymer and inorganic membranes.

### SUMMARY OF THE INVENTION

The present invention discloses a new class of high flux mixed matrix membranes. More specifically, this invention concerns the preparation of new high flux mixed matrix membranes, their manufacture and their use in the separation of components of liquid, vapor, or gas phases. The high flux mixed matrix membranes are made by incorporating porous inorganic fillers (e.g. microporous and mesoporous molecular sieves, carbon molecular sieves, porous metal-organic frameworks) into a high flux high surface area microporous organic polymer matrix. These microporous organic polymers are referred to as “polymers of intrinsic microporosity” or PIMs. The addition of porous inorganic fillers can further enhance the selectivity and/or flux of the high flux PIM polymer membranes. The high flux membranes described in this invention are promising for a wide range of separations including liquid separations such as pervaporation of phenol/water and also gas and vapor separations in the petrochemical, refinery, and natural gas industries such as methane/carbon dioxide, olefin/paraffin and iso/normal paraffins separations.

The polymeric PIM materials exhibit a rigid rod-like, randomly contorted structure which allows them to exhibit intrinsic microporosity. These polymers of intrinsic microporosity exhibit behavior analogous to that of conventional microporous molecular sieve materials, including large and accessible surface areas, interconnected micropores of less than 2 nm in size, as well as high chemical and thermal stability, but, in addition, possess some properties of conventional polymers including good solubility and easy processability. Therefore, the polymeric membranes prepared from these PIM materials exhibited extremely high flux for both liquid and gas phase separations.

In the present invention, the incorporation of porous inorganic fillers such as microporous and mesoporous molecular sieves, carbon molecular sieves, and porous metal-organic frameworks (MOFs) into high flux PIM membranes further enhance the flux and/or selectivity for separations compared to pure PIM membranes. This is due to the combination of solution-diffusion mechanism of polymer membrane and the molecular sieving and sorption mechanism of inorganic membrane.

### DETAILED DESCRIPTION OF THE INVENTION

In the practice of the present invention, the organic microporous polymers (PIMs) are selected as the continuous polymer matrix for the preparation of high flux mixed matrix membranes. These membranes exhibit high flux with the flux of component A of at least 3 ft³ (STP)/ft²·h·100 psig and selectivity of component A/component B of at least 1.1.

Microporous polymer materials (or as so-called “polymers of intrinsic microporosity”, PIMs) are polymeric materials that possess microporosity that is intrinsic to their molecular structures. The PIMs have a rigid rod-like, randomly contorted structure to generate intrinsic microporosity. These PIMs exhibit behavior analogous to that of conventional microporous materials such as large and accessible surface areas, interconnected intrinsic micropores of less than 2 nm in size, as well as high chemical and thermal stability, but, in addition, possess properties of conventional polymers such as good solubility and easy processability. These microporous polymer materials are selected as the membrane materials in the preparation of high flux polymeric and mixed matrix membranes. Representative examples of microporous polymer materials used in the present invention are shown below (PIMs) followed by (network-PIMs).

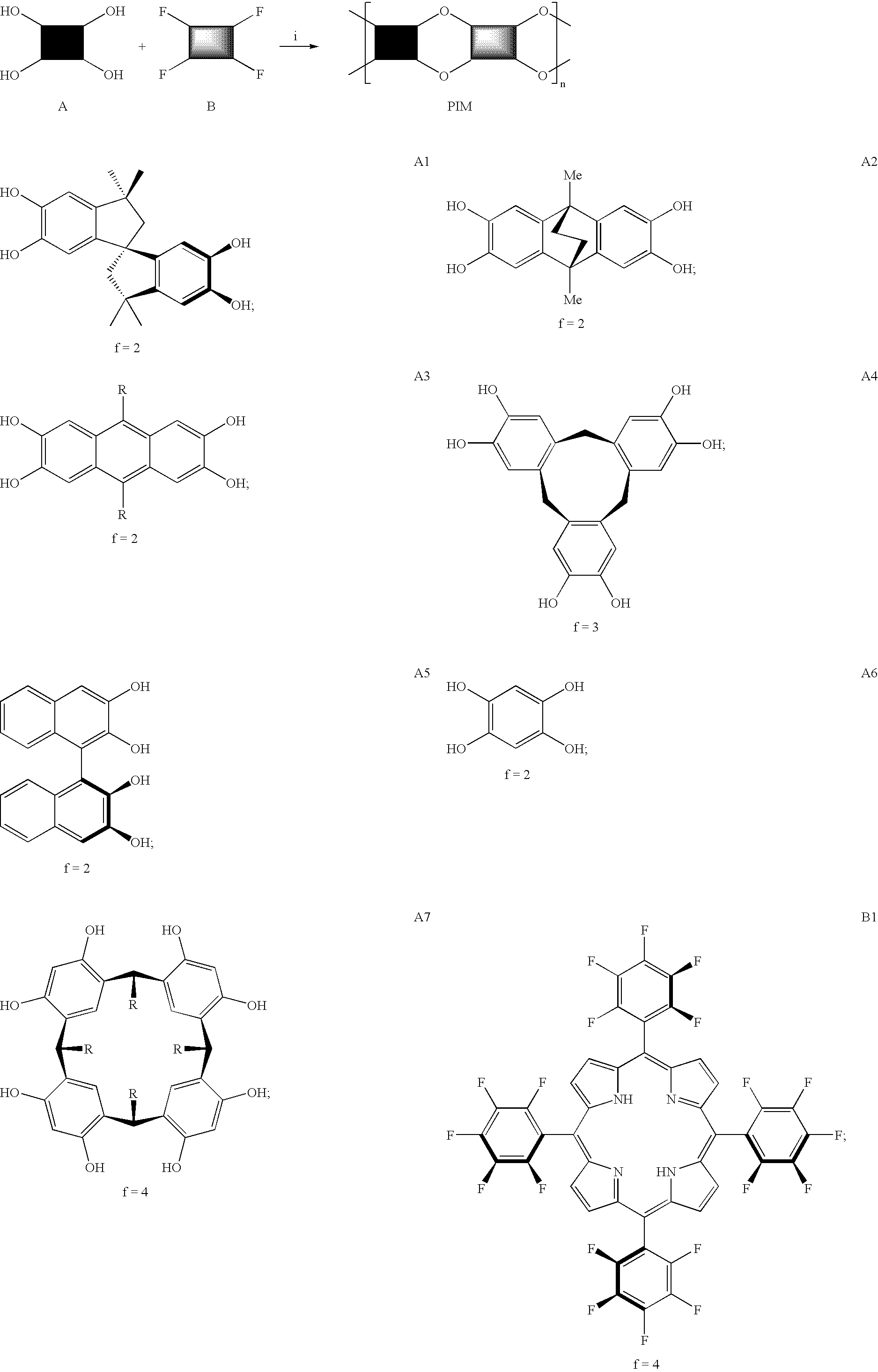

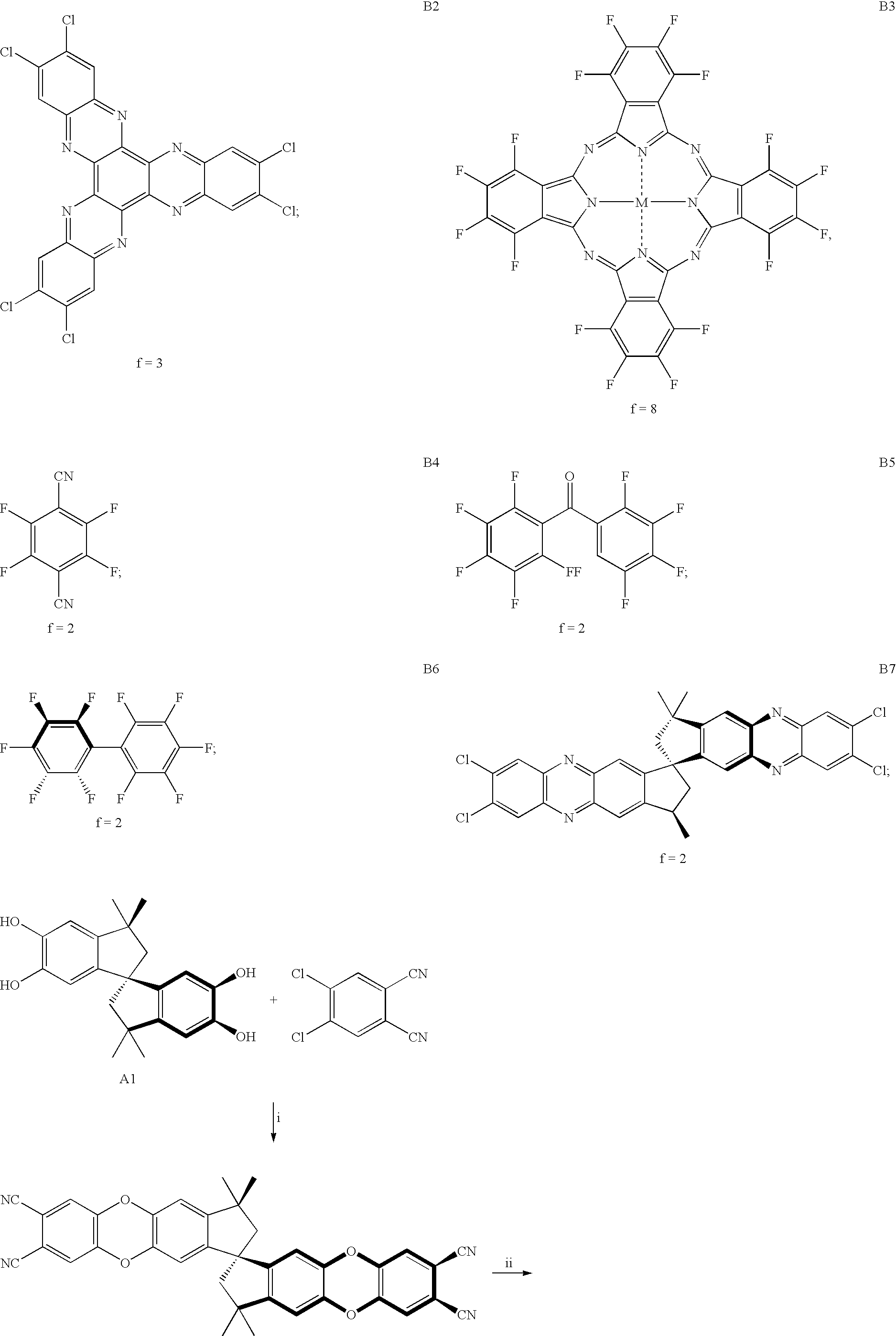

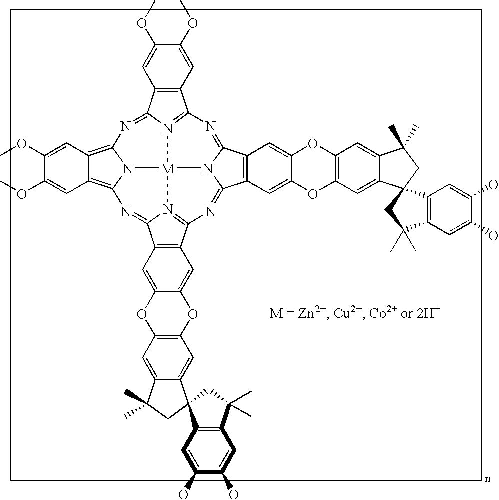

The dioxane formation (i.e., a double aromatic nucleophilic substitution) offers a general reaction for the preparation of PIMs from appropriate hydroxylated aromatic monomers (e.g., A1-A7) and fluorinated (or chlorinated) aromatic monomers (e.g., B1-B7) as shown above. The most preferred microporous polymer materials to be used as the membrane materials with the present invention may be prepared according to the literature procedure. The synthesis of microporous polymer materials is well established in the literature.

For example, for the synthesis of PIM1 from monomers A1 and B4, an efficient dibenzodioxane-forming reaction (i.e. aromatic nucleophilic substitution) between the aromatic tetrol monomer A1 with the appropriate fluorine-containing compound B4 gave a high yield of the soluble PIM1. PIM1 is freely soluble in organic solvents such as methylene chloride, tetrahydrofuran (THF), and dimethylacetamide. The PIM1 was purified by repeated precipitation from THF solution into methanol and when collected by filtration gave a fluorescent yellow free-flowing powder.

The typical organic microporous polymers used in this invention consist essentially of organic macromolecules comprised of first generally planar species connected by rigid linkers predominantly to a maximum of two other said first species, said rigid linkers having a point of contortion such that two adjacent first planar species connected by the linker are held in non-coplanar orientation. This point of contortion is most often provided by a substituted or unsubstituted spiro-indane, bicyclo-octane, biphenyl or binaphthyl moiety. Each of the first planar species comprises at least one aromatic ring.

The present invention includes four types of PIM-based mixed matrix membranes.

The first type of mixed matrix membranes is a microporous molecular sieves-PIM mixed matrix membrane. This type of mixed matrix membrane is expected to exhibit improved flux and/or selectivity for liquid, vapor, or gas phase separations compared to pure PIM polymer matrix. Examples of preferred microporous molecular sieves include: NaX, NaA, AlPO-18, AlPO-14, SAPO-34, SAPO-18, AlPO-17, AlPO-25, AlPO-EN3, AlPO-34, SAPO-44, SAPO-47, SAPO-17, CVX-7, SAPO-35, SAPO-56, AlPO-52, SAPO-43, SSZ-62, SSZ-13, UZM-5, MAPO-34, UZM-9, UZM-26, UZM-27, UZM-25, CDS-1, Nu-6(2), silicalite, Si-MEL, MCM-65, MCM-47, Si-DDR, Si-BEA, 3A, 4A, ITO-3, ITQ-12, Si-CHA, and 5A. Examples of zeolites and their pore indexes can be found in the ATLAS OF ZEOLITE FRAMEWORK TYPES published by the International Zeolite Association. The ATLAS OF ZEOLITE FRAMEWORK TYPES is published on the Internet at (visited Dec. 14, 2005) <http://www.iza-structure.org/databases/> and is from Ch. Baerlocher, W. M. Meier and D. H. Olson, “ATLAS OF ZEOLITE FRAMEWORK TYPES”, 5th edition Elsevier, Amsterdam, 2001.

The second type of mixed matrix membranes are carbon molecular sieves (or activated carbon)-PIM mixed matrix membranes. The carbon molecular sieve or activated carbon fillers also enhance flux and/or selectivity for liquid, vapor, or gas phase separations compared to pure PIM polymer matrix.

The third type of mixed matrix membranes are mesoporous molecular sieve-PIM mixed matrix membranes. Examples of preferred mesoporous molecular sieves include: MCM-41, SBA-15, and surface functionalized MCM-41 and SBA-15, etc.

The fourth type of mixed matrix membranes described in this invention are MOF-PIM mixed matrix membranes. Recently, Simard et al. reported the synthesis of “organic zeolite”, in which rigid organic units are assembled into a microporous, crystalline structure by hydrogen bonds. See Simard et al., J. AM. CHEM. SOC., 113:4696 (1991). Yaghi and co-workers and others have reported a new type of highly porous crystalline zeolite-like materials termed metal-organic frameworks (MOFs). These MOFs are composed of rigid organic units assembled by metal-ligands and possess vast accessible surface areas. See Yaghi et al., SCIENCE, 295: 469 (2002); Yaghi et al., J. SOLID STATE CHEM., 152: 1 (2000); Eddaoudi et al., ACC. CHEM. RES., 34: 319 (2001); Russell et al., SCIENCE, 276: 575 (1997); Kiang et al., J. AM. CHEM. SOC., 121: 8204 (1999); Hoskins et al., J. AM. CHEM. SOC., 111: 5962 (1989); Li et al., NATURE, 402: 276 (1999); Serpaggi et al., J. MATER. CHEM., 8: 2749 (1998); Reineke et al., J. AM. CHEM. SOC., 122: 4843 (2000); Bennett et al., MATER. RES. BULL., 3: 633 (1968); Yaghi et al., J. AM. CHEM. SOC., 122: 1393 (2000); Yaghi et al., MICROPOR. MESOPOR. MATER., 73: 3 (2004); Dybtsev et al., ANGEW. CHEM. INT. ED., 43: 5033 (2004). MOF-5 is a prototype of a new class of porous materials constructed from octahedral Zn—O—C clusters and benzene links. Most recently, Yaghi et al. reported the systematic design and construction of a series of frameworks (IRMOF) that have structures based on the skeleton of MOF-5, wherein the pore functionality and size have been varied without changing the original cubic topology. For example, IRMOF-1 (Zn₄O(R₁-BDC)₃) has the same topology as that of MOF-5, but was synthesized by a simplified method. In 2001, Yaghi et al. reported the synthesis of a porous metal-organic polyhedron (MOP) Cu₂₄(m-BDC)₂₄(DMF)₁₄(H₂O)₅₀(DMF)₆(C₂H₅OH)₆, termed α-MOP-1 and constructed from 12 paddle-wheel units bridged by m-BDC to give a large metal-carboxylate polyhedron. See Yaghi et al., 123: 4368 (2001). These MOF, IR-MOF and MOP materials exhibit analogous behaviour to that of conventional microporous materials such as large and accessible surface areas, with interconnected intrinsic micropores. Moreover, they may reduce the hydrocarbon fouling problem of the polyimide membranes due to the relatively larger pore sizes than those of zeolite materials. MOF, IR-MOF and MOP materials are also expected to allow the polymer to infiltrate the pores, which would improve the interfacial and mechanical properties and would in turn affect permeability. Therefore, these MOF, IR-MOF and MOP materials (all termed MOF herein this invention) can be used as fillers in the preparation of new mixed matrix membranes.

For example, for the synthesis of IRMOF-1, an N,N′-diethylformamide (DEF) solution mixture of Zn(NO₃)₂.4H₂O and the acid form of 1,4-benzenedicarboxylate (BDC) are heated at 105° C. for 20 hours in a closed vessel to give crystalline IRMOF-1, Zn₄O(H—BDC)₃ in 90% yield. Examples of preferred MOF materials include: MOF-5, and Cu—BTC MOF.

High flux PIM-based mixed matrix membranes containing inorganic fillers were fabricated by mixing certain amount of inorganic fillers (e.g. microporous or mesoporous molecular sieves, carbon molecular sieves, or MOFs) in the continuous PIM polymer matrix. The most preferred high flux PIM-based mixed matrix membranes used in this present invention were fabricated as follows. PIM-based mixed matrix dense films were prepared from solution casting of a homogeneous solution of inorganic fillers and the continuous PIM matrix. The solvents that can be used for dissolving PIM matrix include methylene chloride, THF, acetone, DMF, NMP, DMSO, and others known to those skilled in the art. The loading of the inorganic fillers in the mixed matrix dense films may vary from 1 to 70 wt-% depending upon the properties sought as well as the dispersibility of the particular inorganic fillers in the PIM matrix.

Selected amounts of PIM matrix were added to an organic solvent. After stirring for 2 hours, PIMs dissolved completely in the solvent to form a transparent homogeneous solution. Then, a certain amount of inorganic fillers was added to the polymer solution, and the resulting slurry was stirred and ultrasonicated for three times to ensure good dispersion of the inorganic fillers. The polymer solution with inorganic filler loading of 1, 10, 20, 30, 40, and 50 wt-% (based on weight of polymer matrix) was poured into a glass ring on top of a clean glass plate, and dried at room temperature inside a plastic cover for at least 12 hours to obtain the final mixed matrix dense film. The dense film was detached from the glass plate and dried at room temperature for 24 hours and then at 110° C. for at least 48 hours under vacuum.

The permeabilities of propylene (C3=) and propane (C3) (P_{C3=} and P_{C3}) and ideal selectivity for propylene/propane (α_{C3=/C3}) of PIM1-based MMMs for propylene/propane separation were measured by pure gas measurements at 50° C. under 207 kPa (30 psig) single gas pressure.

It has been demonstrated from pure gas permeation results that molecular sieve-PIM1 mixed matrix membranes exhibited a mixed matrix membrane effect for propylene/propane separation with both improved permeability of propylene (P_{C3=}) and selectivity of propylene/propane (α_{C3=/C3}). For example, as shown in Table 1, for the 30% AlPO-14-PIM1 mixed matrix membrane with 30 wt-% of AlPO-14 molecular sieve fillers in PIM1 continuous polymer matrix (i.e., AlPO-14/PIM1=30 wt-%), the P_{C3=} increased 52% compared to that of pure PIM1 membrane, and in the meantime the α_{C3=/C3} increased about 31%.

In addition, the pure gas separation performance of the pure PIM1 membrane for propylene/propane separation is below the polymer upper bound trade-off curve for propylene/propane separation under the same testing conditions. However, with the incorporation of 30 wt-% of AlPO-14 molecular sieve fillers into PIM1 polymer matrix, a 30% AlPO-14-PIM1 mixed matrix membrane was formed and its propylene/propane separation performance is above the polymer upper bound trade-off curve for propylene/propane separation under the same testing conditions.

TABLE 1
Pure gas permeation results for AlPO-14-PIM1 MMM
for propylene/propane separation*

| | P_{C3=} | ΔP_{C3=} | P_{C3} | | |
|---|---|---|---|---|---|
| Dense film | (barrer) | (barrer) | (barrer) | α_{C3=/C3} | Δα_{C3=/C3} |
| PIM1 | 2045.9 | — | 656.7 | 3.12 | — |
| 30% AlPO-14-PIM1 | 3111.4 | 52.1% | 758.7 | 4.10 | 31.4% |

*C3= represents propylene, C3 represents propane, P_{C3=} and P_{C3} were tested at 50° C. and 207 kPa (30 psig); 1 barrer = 10⁻¹⁰ cm³(STP) · cm/cm² · sec · cmHg

As shown in Table 2, for the 30% AlPO-18-PIM1 mixed matrix membrane with 30 wt-% of AlPO-18 molecular sieve fillers in PIM1 continuous polymer matrix (i.e., AlPO-18/PIM1=30 wt-%), the P_{C3=} increased 139% without loss in α_{C3=/C3} compared to that of pure PIM1 membrane.

TABLE 2
Pure gas permeation results for 30% AlPO-18-PIM1
MMM for propylene/propane separation*

| | P_{C3=} | ΔP_{C3=} | P_{C3} | | |
|---|---|---|---|---|---|
| Dense film | (barrer) | (barrer) | (barrer) | α_{C3=/C3} | Δα_{C3=/C3} |
| PIM1 | 2045.9 | — | 656.7 | 3.12 | — |
| 30% AlPO-18-PIM1 | 4882.4 | 139% | 1589.7 | 3.07 | 0 |

*C3 = represents propylene, C3 represents propane, P_{C3=} and P_{C3} were tested at 50° C. and 207 kPa (30 psig); 1 barrer = 10⁻¹⁰ cm³(STP) · cm/cm² · sec · cmHg

In addition, the pure gas separation performance of the pure PIM1 membrane for propylene/propane separation is below the polymer upper bound trade-off curve for propylene/propane separation under the same testing conditions. The propylene/propane separation performance of 30% AlPO-18-PIM1 MMM has reached the polymer upper bound trade-off curve for propylene/propane separation under the same testing conditions.

The permeabilities of CO₂ and CH₄ (P_{CO2} and P_{CH4}) and ideal selectivity for CO₂/CH₄ (α_{CO2/CH4}) of PIM1 membrane and 30% AlPO-18-PIM1 MMM for CO₂/CH₄ separation were measured by pure gas measurements at 50° C. under 690 kPa (100 psig) single gas pressure.

It has been demonstrated from pure gas permeation results as shown in Table 3 that 30% AlPO-18-PIM1 MMM exhibited a mixed matrix membrane effect for CO₂/CH₄ separation with both improved permeability of CO₂ (P_{CO2}) and selectivity for CO₂/CH₄ (α_{CO2/CH4}). The α_{CO2/CH4} increased 60% and in the meantime the P_{CO2} increased 71% for the 30% AlPO-18-PIM1 MMM compared to those of pure PIM1 membrane.

TABLE 3
Pure gas permeation results for 30% AlPO-18-PIM1 MMM
for CO₂/CH₄ separation*

| | P_{CO2} | ΔP_{CO2} | P_{CH4} | | |
|---|---|---|---|---|---|
| Dense film | (barrer) | (barrer) | (barrer) | α_{CO2/CH4} | Δα_{CO2/CH4} |
| PIM1 | 4791.8 | — | 589.6 | 8.13 | — |
| 30% AlPO-18- | 8202.1 | 71% | 630.4 | 13.0 | 60.0% |
| PIM1 | | | | | |

*P_{CO2} and P_{CH4} were tested at 50° C. and 690 kPa (100 psig); 1 barrer = 10⁻¹⁰ cm³(STP) · cm/cm² · sec · cmHg

In summary, it has been demonstrated from the pure gas permeation measurements that the PIM1-based mixed matrix membranes containing porous inorganic fillers described in this invention display extremely high permeability in separation of gases such as propylene/propane separation, suggesting that these new high flux mixed matrix membranes have promising applications not only for a variety of gas separations such as olefin/paraffin separation (e.g. propylene/propane separation), CO₂/N₂, O₂/N₂, iso/normal paraffins, polar molecules such as H₂O, H₂S, and NH₃/mixtures with CH₄, N₂, H₂, and other light gases separations, but also for liquid separations such as pervaporations.

The high flux membranes described in this invention are promising for a wide range of separations including gas/liquid separation processes in the chemical, petrochemical, pharmaceutical and other industries. Such processes include removal of organic vapors from gas streams, e.g. in off-gas treatment for recovery of volatile organic compounds to meet clean air regulations or within process streams in production plants so that valuable compounds (e.g., vinylchloride monomer or propylene) may be recovered. Further examples of gas/liquid separation processes in which the membranes of the present invention may be used are hydrocarbon separation from hydrogen in oil and gas refineries, hydrocarbon dewpointing of natural gas, control of methane number in fuel gas for gas engines and gas turbines and from gasoline recovery. The membranes may also be used in the separation of liquid mixtures by pervaporation, such as in the removal of organic compounds such as alcohols, phenols, chlorinated hydrocarbons, pyridines and ketones from water such as aqueous effluents or process fluids. A membrane which is ethanol-selective would be useful for increasing the ethanol concentration in relatively dilute ethanol solutions obtained by fermentation processes. Further liquid phase examples include the separation of one organic component from another organic component as in the separation of isomers. Mixtures of organic compounds which may be separated using a membrane of the present invention include: ethylacetate-ethanol, diethylether-ethanol, acetic acid-ethanol, benzene-ethanol, chloroform-ethanol, chloroform-methanol, acetone-isopropylether, allylalcohol-allylether, allylalochol-cyclohexane, butanol-butylacetate, butanol-1-butylether, ethanol-ethylbutylether, propylacetate-propanol, isopropylether-isopropanol, methanol-ethanol-isopropanol and ethylacetate-ethanol-acetic acid. The membranes are very useful in gas separation. Examples of such separations include separation of an organic gas such as methane from a smaller inorganic gas such as nitrogen, nitrogen, caronb dioxide or water vapor and removal of metal and organic compounds, low molecular weight compounds and or oligmoers from liquids such as water or organic solvents. An additional application is in chemical reactors to enhance the yield of equilibrium-limited reactions by selective removal of a specific product. Gas separations in the petrochemical, refinery, and natural gas industries such as olefin/paraffin and iso/normal paraffins separations are important uses of these membranes.

1. A process for separating at least one gas from a mixture of gases, the process comprising:
a) providing a mixed matrix gas separation membrane comprising a porous inorganic filler material dispersed in a continuous phase consisting essentially of an organic microporous polymer which is permeable to said at least one gas;
b) contacting the mixture on one side of the mixed matrix membrane to cause said at least one gas to permeate the mixed matrix membrane; and
c) removing from the opposite side of the membrane a permeate gas composition comprising a portion of said at least one gas which permeated said membrane.

2. The process of claim 1 wherein said organic microporous polymer material consists essentially of organic macromolecules comprised of first generally planar species connected by rigid linkers predominantly to a maximum of two other said first species, said rigid linkers having a point of contortion such that two adjacent first planar species connected by the linker are held in non-coplanar orientation.

3. The process of claim 2 wherein said point of contortion is provided by a substituted or unsubstituted spiro-indane, bicyclo-octane, biphenyl or binaphthyl moiety.

4. The process of claim 2 wherein each of the first planar species comprises at least one aromatic ring.

5. The process of claim 1 wherein said porous inorganic filler material is selected from the group consisting of microporous molecular sieves, mesoporous molecular sieves, carbon molecular sieves and porous metal-organic frameworks.

6. The process of claim 5 wherein said microporous molecular sieves are selected from the group consisting of NaX, NaA, AlPO-18, AlPO-14, SAPO-34, SAPO-18, AlPO-17, AlPO-25, AlPO-EN3, AlPO-34, SAPO-44, SAPO-47, SAPO-17, CVX-7, SAPO-35, SAPO-56, AlPO-52, SAPO-43, SSZ-62, SSZ-13, UZM-5, MAPO-34, UZM-9, UZM-26, UZM-27, UZM-25, CDS-1, Nu-6(2), silicalite, Si-MEL, MCM-65, MCM-47, Si-DDR, Si-BEA, 3A, 4A, ITO-3, ITQ-12, Si-CHA, 5A, and mixtures thereof.

7. The process of claim 5 wherein said mesoporous molecular sieves are selected from the group consisting of MCM-41, SBA-15, and surface functionalized MCM-41 and SBA-15 molecular sieves.

8. The process of claim 5 wherein said porous inorganic filler material is a metal organic framework material.

9. The process of claim 1 wherein said mixture of gases comprises a pair of gases selected from the group consisting of hydrogen/methane, carbon dioxide/methane, carbon dioxide/nitrogen, methane/nitrogen and olefin/paraffin.

10. A mixed matrix membrane comprising a porous inorganic filler material dispersed in a continuous phase consisting essentially of an organic microporous polymer.

11. The mixed matrix membrane of claim 10 wherein said microporous polymer material consists essentially of organic macromolecules comprised of first generally planar species connected by rigid linkers predominantly to a maximum of two other said first species, said rigid linkers having a point of contortion such that two adjacent first planar species connected by the linker are held in non-coplanar orientation.

12. The mixed matrix membrane of claim 11 wherein the point of contortion of said microporous polymer material is provided by a substituted or unsubstituted spiro-indane, bicyclo-octane, biphenyl or binaphthyl moiety.

13. The mixed matrix membrane of claim 11 wherein each of the first planar species comprises at least one aromatic ring.

14. The mixed matrix membrane of claim 11 wherein each of the first planar species comprises a substituted or unsubstituted moiety of the formula: 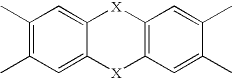
where X is O, S or NH.

15. The mixed matrix membrane of claim 11 wherein the microporous polymer material comprises repeating units of formula: 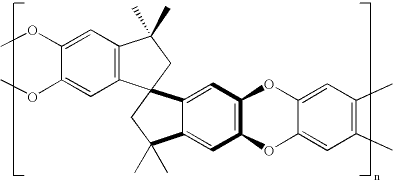
which may be substituted or unsubstituted.

16. The mixed matrix membrane of claim 11 wherein the microporous polymer material comprises repeating units of formula: 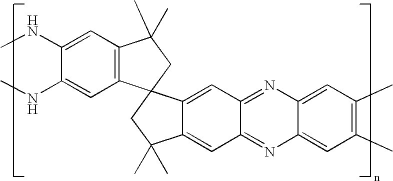
which may be substituted or unsubstituted.

17. The mixed matrix membrane of claim 11 wherein the microporous polymer material comprises repeating units of formula:

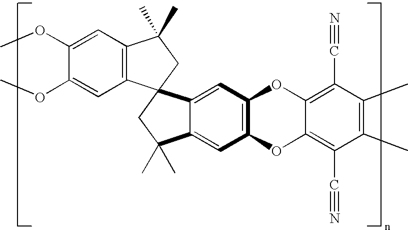

18. The mixed matrix membrane of claim 11 wherein the microporous polymer material comprises repeating units of formula:

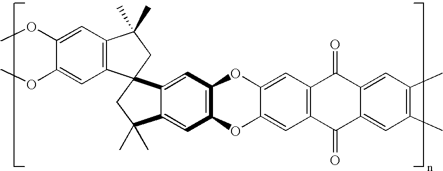

19. The mixed matrix membrane of claim 11 wherein the microporous polymer material comprises repeating units of formula:

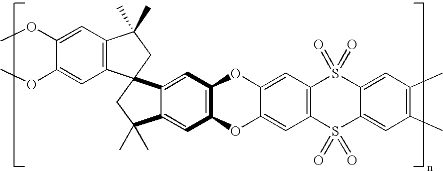

20. The mixed matrix membrane of claim 10 wherein said porous inorganic filler material is selected from the group consisting of microporous molecular sieves, mesoporous molecular sieves, carbon molecular sieves and porous metal-organic frameworks.

21. The mixed matrix membrane of claim 20 wherein said microporous molecular sieves are selected from the group consisting of NaX, NaA, AlPO-18, AlPO-14, SAPO-34, SAPO-18, AlPO-17, AlPO-25, AlPO-EN3, AlPO-34, SAPO-44, SAPO-47, SAPO-17, CVX-7, SAPO-35, SAPO-56, AlPO-52, SAPO-43, SSZ-62, SSZ-13, UZM-5, MAPO-34, UZM-9, UZM-26, UZM-27, UZM-25, CDS-1, Nu-6(2), silicalite, Si-MEL, MCM-65, MCM-47, Si-DDR, Si-BEA, 3A, 4A, ITO-3, ITQ-12, Si-CHA, 5A, and mixtures thereof.

22. The mixed matrix membrane of claim 20 wherein said mesoporous molecular sieves are selected from the group consisting of MCM-41, SBA-15, and surface functionalized MCM-41 and SBA-15 molecular sieves.

23. The mixed matrix membrane of claim 20 wherein said porous inorganic filler material is a metal organic framework material.
